(19) United States
(12) Patent Application Publication
(10) Pub. No.: US 2007/0141349 A1
(43) Pub. Date: Jun. 21, 2007

(54) Alkaline glasses with modified glass surfaces and process for the production thereof

(76) Inventors: Heiko Hessenkemper, Grossschirma (DE); Heide Landermann-Hessenkemper, Grossschirma (DE)

Correspondence Address: HAHN LOESER & PARKS, LLP, One GOJO Plaza, Suite 300, AKRON, OH, 44311-1076, US

(21) Appl. No.: 10/553,011

(22) PCT Filed: Apr. 30, 2004
(86) PCT No.: PCT/EP04/04642

§ 371 Date: Jun. 26, 2006

(30) Foreign Application Priority Data
May 2, 2003 (DE) 10319708.7

(51) Int. Cl. C03C 15/00; B32B 17/00

(52) U.S. Cl. 428/410; 65/30.1

(57) ABSTRACT

The invention concerns alkaline glasses with modified glass surfaces. The technical object of the invention is to stabilize the modified glass surface so that reverse sodium diffusion out of the volume is substantially avoided even at elevated temperatures and in particular in the case of post-treatment procedures using a flame. Surprisingly it was found that a modified glass surface of an alkaline glass is substantially resistant to reverse sodium diffusion from the volume at elevated temperatures if the chemism within the surface has an aluminum concentration which is markedly increased in relation to the volume. The cause can be the very high level of negative formation enthalpy of albite phases. The process according to the invention is characterized in that the surface of said glasses is brought into contact with elevated levels of aluminum concentration and is subjected to a heat treatment.

### TECHNICAL FIELD

The technical object of the invention is to stabilize the modified glass surface in such a way that, in contrast to the state of the art, reverse sodium diffusion out of the volume is substantially avoided even at elevated temperatures and in particular in post-treatment procedures using a flame.

### BACKGROUND OF THE INVENTION

Among the use of glasses, the surface properties play an essential part in regard to interaction with the environment, in which respect mention is to be made here in particular of chemical and mechanical properties. For various reasons which involve inter alia fusibility and fusing technology, relatively high alkali contents are frequently desired, which on the other hand however result in a deterioration in hydrolytic resistance and mechanical properties. A hitherto usual way of resolving that dilemma is a surface treatment which is generally described by dealkalization processes as are set forth in summarized form in [1: Glastechnische Fabrikationsfehler, H. J. Jebsen-Marwedel, R. Brückner: Springer-Verlag 1980, pages 507-508] and [2: patent application at the German Patent and Trade Mark Office: Process for the production of enamels, filing No 102 46 928.8]. In regard to that array of problems in regard to dealkalization, for example due to the influence of hydrogen sulfide and so forth, a fundamental problem which arises is that high reaction temperatures are generally necessary for a high level of reactivity, but it will be noted that those high reaction temperatures can again result in reverse sodium diffusion out of the volume to the surface. Particularly in the case of later treatment processes such as post-treatment with a flame which is linked to high temperatures, thermally induced reverse sodium diffusion out of the volume can result in a significant worsening in the properties originally achieved.

### SUMMARY OF THE INVENTION

It was found that a modified glass surface of an alkaline glass is substantially resistant to reverse sodium diffusion out of the volume at elevated temperatures if the chemism within the surface has a concentration of aluminum which is markedly increased in relation to the volume. The cause can lie in the very high level of negative formation enthalpy of albite phases. The process according to the invention is characterized in that the surface of said glasses is brought into contact with elevated aluminum concentrations and is subjected to a heat treatment. That results in the production of thermally stable surface layers which, with the sodium alumosilicates formed, in the region near the surface, have a resistance to thermally induced reverse sodium diffusion as there are no concentration gradients and the sodium is more firmly bound in that aluminum-modified structure.

The process for applying those layers is preferably implemented by aluminum-bearing solutions such as for example aqueous solutions of aluminum chloride and/or alum being applied to the surface of the glass, for example by dip or spray processes, whereupon then the glass surface is heated into the region of the transformation temperature for some minutes. In that case the aluminum compounds are used in an amount of at least 0.1 g/m² of glass surface area, preferably in an amount of between 1 and 10 g/m² glass surface area. The respective upper limits are due to the saturation concentration of the aluminum compounds in the solution. The glass surface is preferably heated to the region of the transformation temperature ±150 K. Operating with aluminum-bearing solutions results in part in optical detractions, by virtue of the wetting characteristics.

Optical detractions can be avoided if at high temperatures the aluminum-bearing material is deposited out of the gaseous phase at the glass surface and in that case involves the necessary compounds. In that respect the aluminum chloride is used at least in an amount of 0.1 g/m³ of contacting volume, preferably in an amount of between 1 and 10 g/m³. The upper limit is determined by the saturation vapor pressure. The temperature of the aluminum chloride compounds is between the sublimation temperature of 170° C. and up to 600 K above the transformation temperature of the glass. The duration of the operation of contacting the glasses with aluminum chloride compounds from the gaseous phase is at least 0.1 second at high temperatures and up to an hour at low temperatures. The sample temperature of the glass surface is limited downwardly by the temperature change resistance of the glass. The upper limit can be up to 600 K above the transformation temperature of the glass. When operating with aluminum chlorides in the gaseous phase, possible weak residues are easy to wash out. When using aluminum chloride, a distinction is to be drawn between use with water of crystallization and without water of crystallization. With water of crystallization, a greater degree of surface modification and increase in hydrolytic resistance and the microhardness of the glasses is to be found, without optical detraction. When using water-free aluminum chloride perceptible optical detractions are rather to be observed.

The process according to the invention can also advantageously be used in tube glass manufacture. In tube glass manufacture, the Vello or Danner processes involve causing air to flow against the inside surfaces of the glass tubes as a blowing medium under an increased pressure. It is appropriate to use heated air at over 170° C., in which there is vaporized AlCl₃. That firstly avoids condensation. Then, downstream of the drawing bulb, that gas comes into contact with the hot inside surface of the gas, in which case modification of the glass surface can then take place. The gas then flows out of the tube opening at the cold end of the tube portion and thus has time to react with the glass surface over a period of up to several minutes and at high temperatures (up to 600 K above Tg), until the glass cutting operation. In that respect, to avoid condensation phenomena, it may be necessary to keep the cutting temperature of the tube above 170° C.

### BRIEF DESCRIPTION OF THE DRAWINGS

FIG. 1 is a graph showing the hydrolytic resistance of white bottles of soda lime silicate glass having various amounts of treatment with an aluminum chloride compound solution and heat treatment;

FIG. 2a are multiple element specific graphs showing the intensities of the presence of the element made by a microprobe over a scan length of 30 μm on the surface of an untreated bottle; and FIG. 2b are multiple element specific graphs showing the intensities of the presence of the element made by a microprobe over a scan length of 30 μm on the surface of a glass treated in accordance with the present invention;

FIG. 3 is graph showing the hydrolytic resistance of bottles that were treated in accordance with the present invention and untreated bottles some of which were subjected to flame treatment for various times after cooling; and

FIG. 4 is a graph showing the variation of microhardness as it varies with the depth of penetration for an untreated glass sample and two treated glass samples.

### DETAILED DESCRIPTION OF THE INVENTION

### EXAMPLE 1

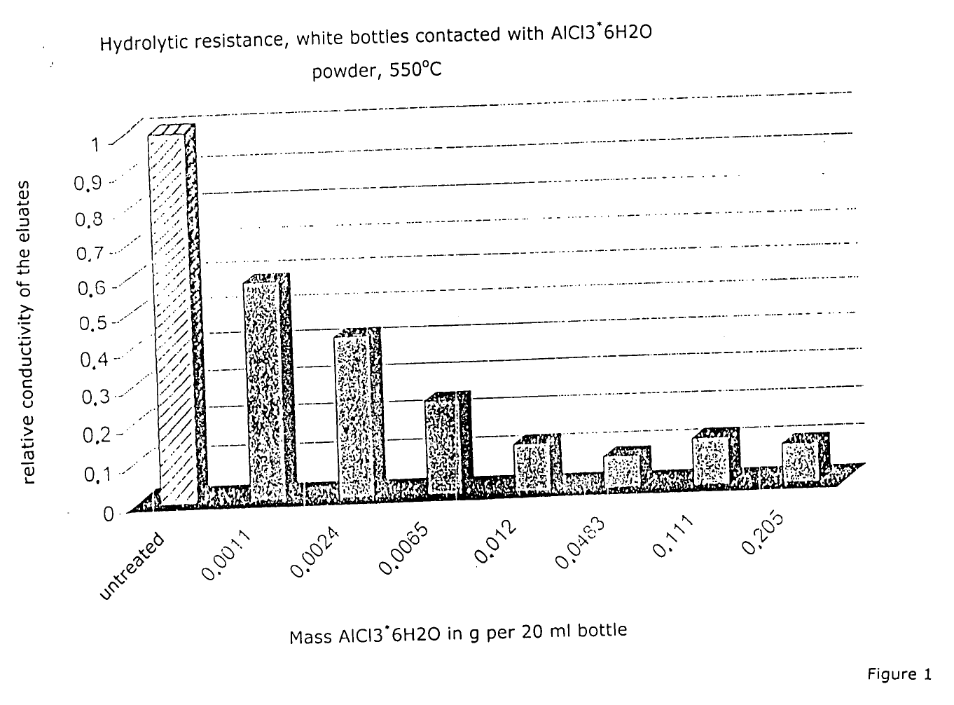

As typical results FIG. 1 shows the hydrolytic resistance of white bottles of soda lime silicate glass of the following composition: 71.0% SiO₂, 1.7% Al₂O₃, 0.02% Fe₂O₃, 1.3% K₂O, 15.5% Na₂O, 9.4% CaO, 2.7% MgO and 0.2% SO₃, wherein the samples were put with various amounts of AlCl₃.6 H₂O in an furnace at temperatures of 550° C. and then cooled down therein. The amounts of aluminum chloride introduced into the container related to a provided glass surface of 3814 mm² and a volume of 20 ml, in which respect water-free aluminum chloride was to go into the vapor phase at 180° C. or, according to our own DTA measurements the material, with water of crystallization, breaks down only at temperatures of 203° C. The containers were placed over the sample material and cooled after 15 minutes treatment time in the muffle furnace. Table 1 shows different treatment steps in regard to their effect on hydrolytic resistance.

TABLE 1

| | Conductivity μS | | |
|---|---|---|---|
| Sample | Measurement | Measurement | |
| identification | 1 | 2 | Treatment |
| I | 6.5 | 5.9 | 0.01 g AlCl₃ * 6H₂O + |
| | | | 4.49 μl H₂O |
| II | 12.0 | 6.7 | 0.01 g AlCl₃ * 6H₂O |
| III | 4.1 | 4.2 | 0.0055 g AlCl₃ + 4.9 μl |
| | | | H₂O |
| IV | 4.2 | 5.2 | 0.0055 g AlCl₃ + 13.3 μl |
| | | | H₂O |
| V | 27.6 | 29.8 | 10.37 μl HCl |
| VI | 19.0 | 18.0 | 31 μl HCl |
| VII | 63.9 | 61.9 | 4.49 μl H₂O |
| VIII | 65.1 | 61.4 | 13.5 μl H₂O |
| IX | 67.1 | 56.4 | 40 μl H₂O |
| WF20 | 61.2 | 60.4 | untreated |

T = 550° C., 10 minutes treatment time
Measured conductivity:
48 h at 90° C. in distilled water
20 ml internal volume covered with Al film

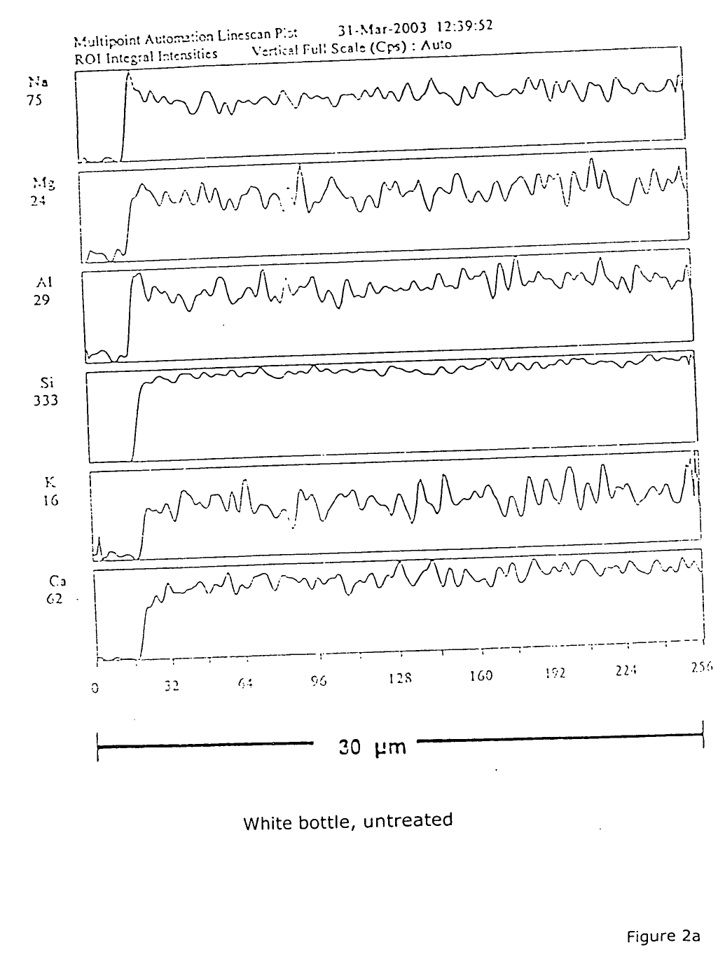

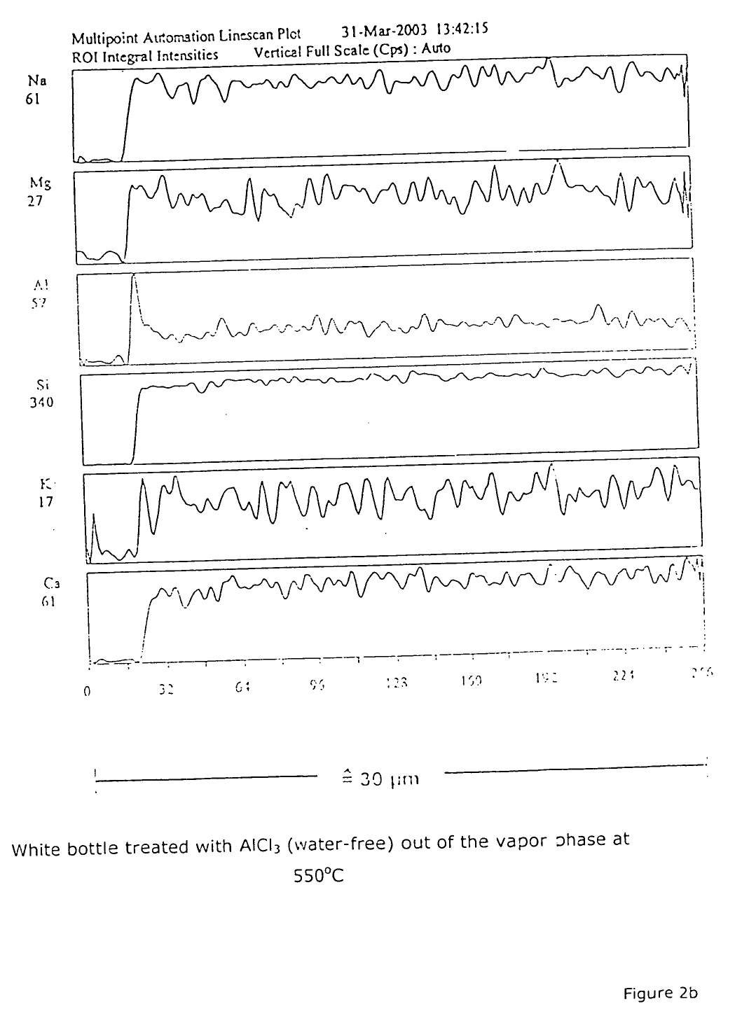

FIG. 2a (untreated glass) and FIG. 2b (glass treated according to the invention) showed the line scan recorded with a microprobe over a length of 30 μm with the element-specific signal intensities of that white glass being investigated. The aluminum concentration at the surface, in a region of smaller than 1 μm, with the process in accordance with the invention, becomes clear.

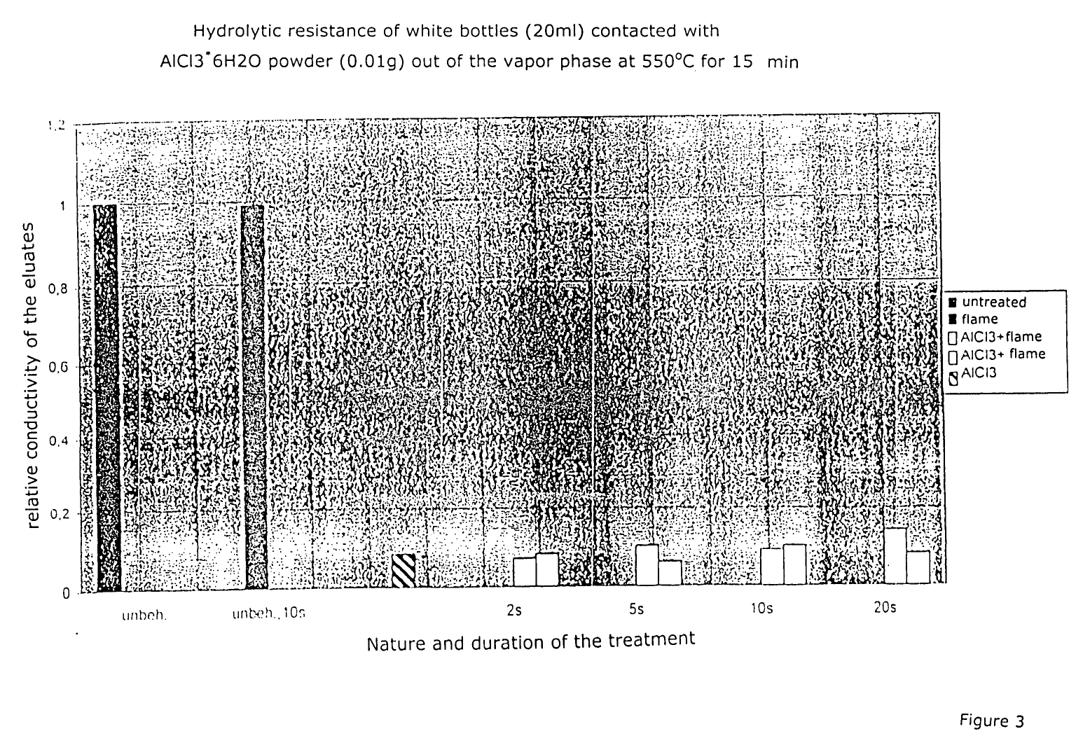

The thermal stability of the layers is clearly shown in FIG. 3 which also shows the treatment steps. After conclusion of the treatment the glasses are subjected in the cold condition to a flame treatment. It was found that the markedly improved levels of hydrolytic resistance are reproducibly maintained.

### EXAMPLE 2

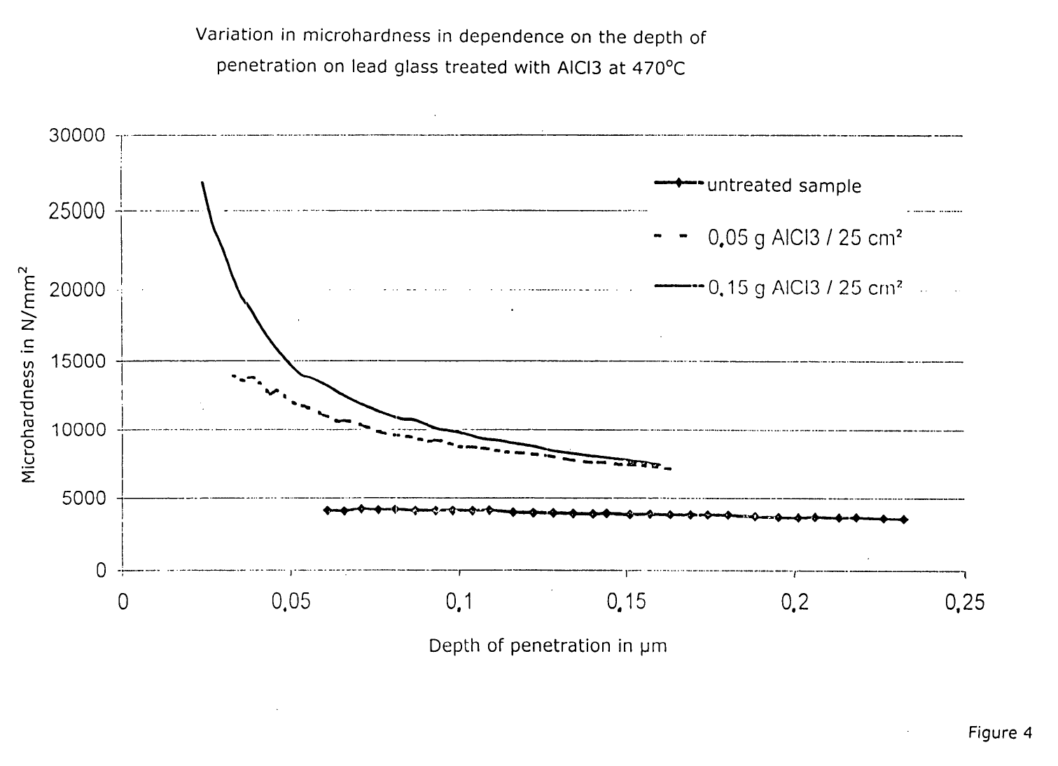

In the case of a lead crystal glass, a defined amount (0.05 g and 0.15 g) of AlCl₃, together with a glass sample of 25 cm², was put in a muffle furnace into a corundum pot which was covered with aluminum film. After heating to 470° C. and a hold time of 15 minutes with the muffle furnace being finally switched off and the samples cooled down in the pot, the glasses were analyzed in regard to microhardness. The results are shown in FIG. 4 and exhibit a microhardness which is increased by a good 100% after 150 nm depth of penetration, which can assume even much higher values at still lower depths of penetration.

1. An alkaline glass comprising:
a modified glass surface comprising an aluminum concentration which is markedly increased in relation to the aluminum concentration of the volume of the glass.

2. A process for the production of alkaline glasses with a modified glass surface, the process comprising the steps of:
bringing the surface of said glasses into contact with elevated levels of aluminum concentrations; and
subjecting the surface of said glasses to a heat treatment.

3. The process of claim 2, wherein said elevated levels of aluminum concentration comprises alum (K Al (SO₄)₂×12 H₂O) and/or AlCl₃ with and without water of crystallization.

4. The process of claim 2, wherein aluminum compounds in soluble form are applied to the surface of said glasses by dipping or spraying prior to the step of subjecting the glasses to heat treatment.

5. The process of claim 2, wherein the elevated levels of aluminum concentration comprise an amount of at least 0.1 g/m² of glass surface area; and wherein the glass surface is then heated into the region of the transformation temperature of the glass ±150 K.

6. The process of claim 2, wherein the surface of said glasses is brought into contact with aluminum chloride compounds from the vapor phase for between 0.1 second and an hour.

7. The process of claim 6, wherein the aluminum chloride compounds used correspond to an amount of at least 0.1 g/m³ of contacting volume and the lower sample temperature of the glass surface is limited by the temperature change resistance of the glass and the upper sample temperature of the glass surface is up to 600 K above the transformation temperature of the glass.

8. The process of claim 6, wherein the temperature of the aluminum chloride compounds is between the sublimation temperature of 170° C. and up to 600 K above the transformation temperature of the glass.

9. The process of claim 6, wherin the process is used in tube glass production and said gaseous phase aluminum chloride compound is urged through a tube similarly to the air in the Vello or Danner process.

10. A process for modifying the surface of an alkaline glass comprising the steps of:
bringing the surface of the alkaline glass into contact with an aluminum compound in solution or vapor form; and
subjecting the surface of the glass to a heat treatment.

11. The process of claim 10, wherein the aluminum compound comprises (K Al (SO₄)₂×12 H₂O) and/or AlCl₃.

12. The process of claim 10 wherein the step of bringing the surface of the alkaline glass into contact with an aluminum compound in solution or vapor form is accomplished by spraying a solution comprising an aluminum compound on the surface of the alkaline glass or dipping the alkaline glass in a solution comprising an aluminum compound.

13. The process of claim 12, wherein the application of aluminum compound on the surface of the alkaline glass is accomplished in an amount of at least 0.1 g/m² of glass surface area.

14. The process of claim 10, wherein the surface of the alkaline glass is brought into contact with an aluminum chloride vapor for between 0.1 second and an hour.

15. The process of claim 14, wherein the application of aluminum compound on the surface of the alkaline glass is accomplished in an amount of at least 0.1 g/m³ of contacting volume.

16. The process of claim 15, wherein the temperature of the aluminum chloride compounds is between 170° C. and up to 600 K above the transformation temperature of the glass.
